(19) United States
(12) Patent Application Publication
(10) Pub. No.: US 2023/0078626 A1
(43) Pub. Date: Mar. 16, 2023

(54) ELECTRONIC DEVICE, METHOD FOR CONTROLLING HAND, AND RECORDING MEDIUM

(71) Applicant: CASIO COMPUTER CO., LTD., Tokyo (JP)

(72) Inventor: Tatsuyoshi OMURA, Tokyo (JP)

(73) Assignee: CASIO COMPUTER CO., LTD., Tokyo (JP)

(21) Appl. No.: 17/888,882

(22) Filed: Aug. 16, 2022

(30) Foreign Application Priority Data
Sep. 13, 2021 (JP) 2021-148285

(51) Int. Cl. G04G 21/02; G04G 9/00; G04B 47/06

(52) U.S. Cl. CPC G04G 21/025; G04G 9/007; G04B 47/063

(57) ABSTRACT

An electronic device includes a display to display information with a hand and at least one processor, in which the processor is configured to acquire the number of pulsations of a living body during a predetermined period and control the display to express a pulsation period based on the acquired number of pulsations of the living body with the hand.

### CROSS-REFERENCE TO RELATED APPLICATION

This application claims the benefit of Japanese Patent Application No. 2021-148285, filed on Sep. 13, 2021, the entire disclosure of which is incorporated by reference herein.

### FIELD

The present disclosure relates to an electronic device, a method for controlling a hand, and a recording medium.

### BACKGROUND

Recent years, electronic devices, such as a wristwatch, that are worn on the body and measure biometric information, such as a pulse rate, using a sensor, such as an optical sensor, have been developed. Although many of such electronic devices display a pulse rate numerically, there are some cases where, even when a pulse rate is displayed numerically, grasping how fast the heart is actually pulsating is difficult. In order to solve this problem, for example, a watch that enables a measurement result of a pulse rate to be intuitively grasped is disclosed in Unexamined Japanese Patent Application Publication No. 2017-187356 (Patent Literature 1).

In the watch disclosed in Patent Literature 1, setting the number of times that a hand is moved during a rotation of the hand substantially the same as the pulse rate, that is, moving the hand with substantially the same period as that of pulsation of the heart, enables the pulse rate to be intuitively grasped. However, because of this configuration, the larger the pulse rate becomes, the smaller an angle by which the hand rotates in one movement becomes, which causes the movement of the hand to be difficult to grasp. For example, since, when the pulse rate is greater than or equal to 180 beats per minute (bpm), an angle by which the hand rotates in one movement becomes less than or equal to only 2 degrees, the movement of the hand becomes substantially difficult to grasp.

### SUMMARY

An electronic device according to one aspect of the present disclosure includes:
a display to display information with a hand; and
at least one processor,

wherein the processor is configured to:
acquire a number of pulsations of a living body during a predetermined period; and
control the display to express a pulsation period based on the acquired number of pulsations of the living body with the hand.

Further features of the present invention will become apparent from the following description of exemplary embodiments (with reference to the attached drawings).

### BRIEF DESCRIPTION OF THE DRAWINGS

A more complete understanding of this application can be obtained when the following detailed description is considered in conjunction with the following drawings, in which:

FIG. 1 is a block diagram illustrating an example of a functional configuration of an electronic device according to an embodiment;

FIG. 2 is a diagram illustrating an example of a PPG waveform;

FIG. 3 is a diagram illustrating an example of an external appearance of the electronic device when viewed from the front side;

FIG. 4 is a diagram illustrating an example of an external appearance of the electronic device when viewed from the back side;

FIG. 5 is an example of a flowchart of hand control processing according to the embodiment;

FIG. 6 is an example of a flowchart of a hand oscillation thread according to the embodiment;

FIG. 7 is a diagram illustrating an example of a manner of oscillation of a hand in a small hand display according to the embodiment;

FIG. 8 is a diagram illustrating an example of a manner of oscillation of a second hand according to the embodiment; and

FIG. 9 is a diagram illustrating an example of an ECG waveform.

### DETAILED DESCRIPTION

An electronic device and the like according to an embodiment is described with reference to the drawings. Note that, in the drawings, the same or equivalent constituent elements are designated by the same reference numerals.

### Embodiment

An electronic device according to the embodiment is a wristwatch-type device that is capable of measuring a pulse rate of a user by being worn on a wrist of the user, and is, for example, a smartwatch.

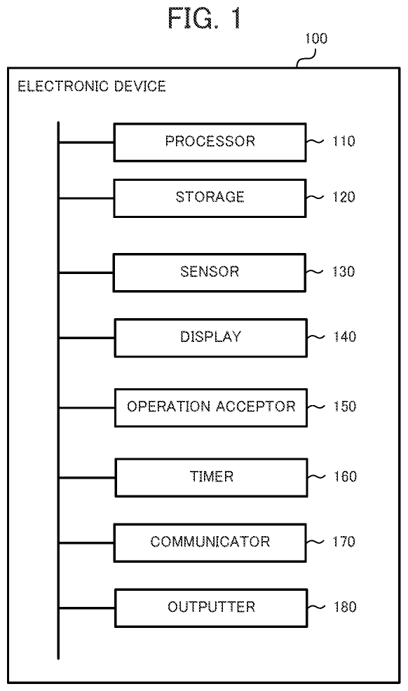

An electronic device 100 according to the embodiment includes a processor 110, a storage 120, a sensor 130, a display 140, an operation acceptor 150, a timer 160, a communicator 170, and an outputter 180, as illustrated in FIG. 1.

The processor 110 includes a processor, such as a central processing unit (CPU). The processor 110 executes hand control processing and the like, which are described later, by executing programs stored in the storage 120. In addition, the processor 110 has a capability of performing multi-thread processing and is thus capable of executing a plurality of processes in parallel.

The storage 120 stores programs that the processor 110 executes and data necessary for the execution of the programs. The storage 120 may include a random access memory (RAM), a read only memory (ROM), a flash memory, or the like, but not limited thereto. Note that the storage 120 may be installed inside the processor 110.

The sensor 130 includes a photoplethysmography (PPG) sensor, which includes a light emitting diode (LED) and a photodiode (PD), and detects a pulse wave. However, the sensor 130 may include a sensor other than the PPG sensor as long as the sensor is capable of detecting pulsation of a living body. For example, the sensor 130 may include an electrocardiogram (ECG) sensor to be worn on the chest and detect heartbeats. In the present embodiment, however, the description is made assuming that the sensor 130 includes a PPG sensor to be worn on a wrist.

The sensor 130 receives, by the PD, light that was generated when light having been emitted from the LED toward a living body was reflected inside the living body, and detects intensity of the received light as a biometric signal representing a pulse wave. The processor 110, by analyzing temporal change in values to which the received light intensity at the PD is analog-to-digital (AD) converted by an AD converter (AD values), calculates a peak to peak interval (PPI) and a pulse rate (a heart rate). Note that a pulse wave sensor 131 may include an analog front end (AFE). Even when the received light intensity at the PD (analog signal) is too weak to be directly AD converted, adjusting the analog signal using the AFE enables the analog signal to be AD converted.

Note that a PPI acquirable by the PPG sensor is a time interval from a peak value to the next peak value of AD values and is also referred to as a beat to beat interval (BBI). In addition, the PPI and the BBI basically coincide with an R-R interval (RRI), which is a time interval between an R wave and an R wave of an electrocardiogram acquired by an ECG sensor. Since the name RRI is most widely accepted among the names PPI, BBI, and RRI, a time interval of this type, including a time interval referred to as a PPI or a BBI, is referred to as an RRI in the following description. In addition, since a pulse rate and a heart rate basically coincide with each other, both a pulse rate and a heart rate are referred to as a pulse rate in the following description.

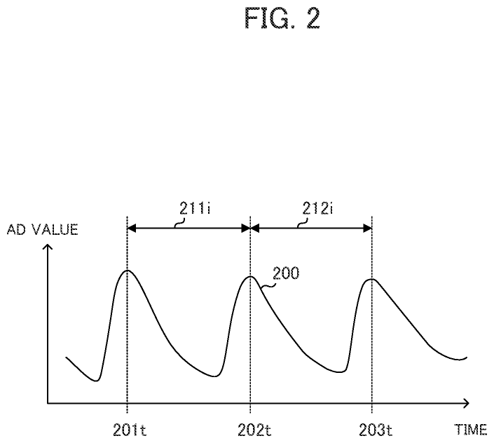

The processor 110 is capable of acquiring a waveform 200 (PPG waveform), which represents temporal change in AD values, as illustrated in, for example, FIG. 2, using the PPG sensor. The processor 110 is also capable of acquiring a time interval between peaks (RRI) by detecting peaks (local maximum points) in the waveform 200. Note that a time at which the waveform 200 reaches a peak is referred to as a peak timing. In addition, since a pulse rate is the number of pulses per unit time (one minute), when it is assumed that the unit at the time of representing a value of RRI is a second, the relationships below hold:

average value of RRI for one minute during which the pulse rate is measured=60/pulse rate; and

pulse rate when it is assumed that the same RRI continues=60/RRI.

The display 140 includes physical hands and a display device, such as a liquid crystal display and an organic electro-luminescence (EL) display. The display 140 displays a pulse rate measured by the sensor 130, a time timed by the timer 160, and the like. Note that the display 140 may include an analog time display including physical hands (a second hand, a minute hand, and an hour hand), a day wheel, a motor driver, a motor, and a wheel train mechanism. In addition, the display 140 may, instead of including a physical analog time display, perform analog time display by displaying hands on a display device, such as a liquid crystal display.

The operation acceptor 150 is a user interface including a crown, a push-button switch, and the like and accepts operation input from the user. The processor 110 is capable of acquiring what operation input the user has performed, based on detection results, such as a rotational state of the crown and a pressed state of the switch of the operation acceptor 150. Note that, when the electronic device 100 includes a touch panel integrated with the display 140, the touch panel also serves as the operation acceptor 150 and accepts a tap operation and the like performed by the user.

The timer 160 times the time that the electronic device 100 displays on the display 140. The timer 160 also has a function of a timer to measure a specified time period. Note that the timer 160 may be configured by software that changes a value to be stored at a predetermined address in the storage 120 every predetermined time period (for example, one second) or configured by dedicated hardware. Note also that the timer 160 may be installed inside the processor 110.

The communicator 170 is a communication interface for the electronic device 100 to perform data communication with an external device (such as a smartphone, a tablet, a personal computer (PC), and another smartwatch) and acquire information from the Internet. The communicator 170 may include a wireless communication interface for performing communication using, for example, Bluetooth (registered trademark) or a wireless local area network (LAN), but not limited thereto.

The outputter 180 includes a speaker and outputs a voice announcement and sound effects. Note that the electronic device 100 may include, instead of a speaker or in addition to a speaker, an LED (light emitter) or a vibrator as the outputter 180.

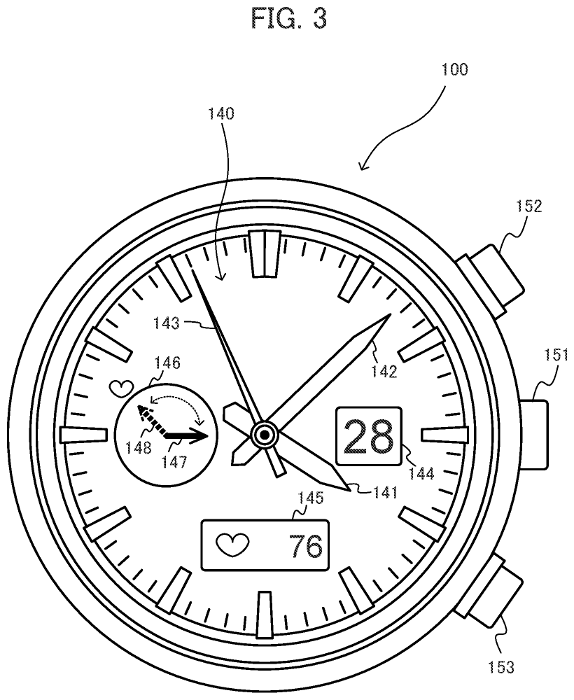

In appearance, the electronic device 100 includes an hour hand 141, a minute hand 142, a second hand 143, a day wheel 144, a pulse rate display 145, and a small hand display 146 as the display 140 on the front side, as illustrated in FIG. 3. The electronic device 100 displays a time, a date, and a pulse rate of the user by the hour hand 141, minute hand 142, and second hand 143, the day wheel 144, and the pulse rate display 145, respectively. While the small hand display 146 is capable of displaying various information according to functions of the electronic device 100, the small hand display 146, as one of the functions, expresses pulsation of the heart by oscillation (rotation and counter-rotation the oscillation width of which is a standard rotation angle) of a hand 147.

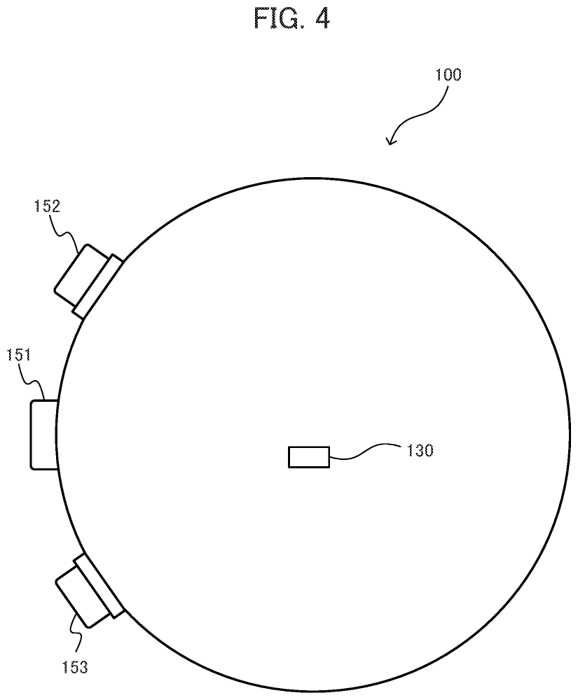

In addition, the electronic device 100 includes a crown 151 and push-button switches 152 and 153 on the lateral side, as illustrated in FIG. 3, and accepts operation performed thereon by the user. The electronic device 100 also includes the LED and the PD as the sensor 130 on the back side, as illustrated in FIG. 4. The processor 110 calculates an RRI and a pulse rate, based on temporal change in received light intensity (AD values) detected by the PD of the sensor 130.

For example, the processor 110, by detecting peak values of the AD values, extracts beat times 201t, 202t, and 203t and acquires intervals 211i and 212i between the beat times as RRIs, as illustrated in FIG. 2. The processor 110 also acquires the number of peak values per minute as a pulse rate.

The electronic device 100, as well as displaying a pulse rate on the pulse rate display 145, expresses pulsation of the heart by oscillation of the hand 147 in the small hand display 146. FIG. 3 illustrates a manner in which the pulse rate being 76 beats per minute (bpm) is displayed on the pulse rate display 145 and the pulsation of the heart is expressed by oscillation of the hand 147. The hand 147 expresses oscillation, the oscillation width of which is the standard rotation angle, by rotation from a start location of oscillation (base location) to a location of a local maximum point (peak location) and the succeeding counter-rotation.

In FIG. 3, an example is illustrated in which, with the start location of oscillation by the hand 147 set as the base location (the location of the hand 147 in FIG. 3), the processor 110, by causing the hand 147 to rotate from the base location to a peak location (the location of a hand 148 illustrated by a dotted line in FIG. 3) and subsequently causing the hand 147 to counter-rotate from the peak location to the base location, causes the hand 147 to oscillate and thereby expresses the pulsation of the heart. Velocity (rotational velocity) of the hand 147 at the time of the rotation and counter-rotation may be changed according to the pulse rate. For example, the processor 110 controlling the rotational velocity in such a manner that the higher the pulse rate is, the higher the rotational velocity becomes, enables the user to easily grasp the magnitude of the pulse rate intuitively through speed (period) of oscillation of the hand.

In addition, the base location and the peak location do not have to be fixed locations. For example, fixing the base location and setting the standard rotation angle, which is the oscillation width of oscillation, (in the example in FIG. 3, an angle formed by the base location and the peak location) in such a manner that the higher the pulse rate is, the larger the standard rotation angle becomes, enable the user to easily grasp the magnitude of the pulse rate intuitively through the amplitude of oscillation (oscillation width) of the hand.

In addition, although, in FIG. 3, an example in which the pulsation of the heart is expressed by oscillation of the hand 147 in the small hand display 146 is illustrated, the method for expressing the pulsation of the heart is not limited to the method using the small hand display 146. The electronic device 100 may express the pulsation of the heart by another hand (for example, the second hand 143). In this case, although, for example, the second hand 143 suspends indicating seconds of the current time while expressing the pulsation, a time period during which the pulsation is expressed is limited to a short period of time (for example, only a period of 0.2 seconds within a one-second period). Therefore, even when the pulsation of the heart is expressed by a hand to display a time, the user is able to confirm a time without any difficulty. In addition, when the pulsation of the heart is expressed by a hand to display a time, the electronic device 100 is able to express the pulsation of the heart even without including the small hand display 146.

When the pulsation of the heart is expressed by the second hand 143, the processor 110 sets the base location of oscillation to a location indicating seconds of the current time. Because of this configuration, even when the pulsation of the heart is expressed by the second hand 143, the user is able to confirm seconds of the current time with the second hand 143. In addition, in this case, the standard rotation angle may also be determined, for example, in such a manner that the higher the pulse rate is, the larger the standard rotation angle becomes. This configuration enables the user to easily grasp the magnitude of the pulse rate intuitively through the amplitude of oscillation (oscillation width).

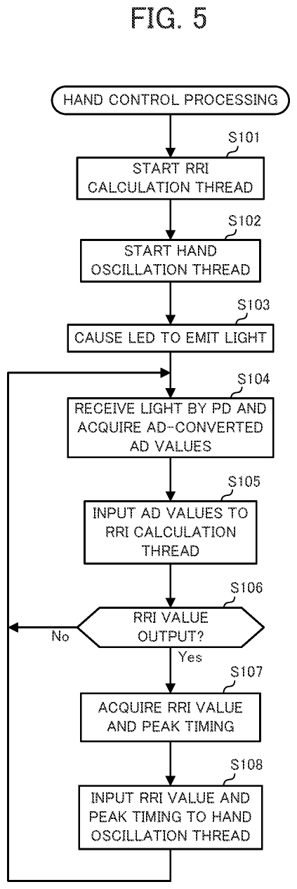

Next, the hand control processing, which is processing of the electronic device 100 causing a hand to express the pulsation of the heart, is described with reference to FIG. 5. The hand control processing is started when the user instructs the electronic device 100 to perform pulsation expression with a hand through the operation acceptor 150. In addition, the electronic device 100 may be configured to, when being started up, start the execution of the hand control processing in parallel with other processing.

When the hand control processing is started, the processor 110 first starts an RRI calculation thread (step S101). The RRI calculation thread is processing that is executed in parallel with the hand control processing and, when AD values are input in a chronological order, detects local maximum points (peaks) of the AD values and outputs a value of the latest RRI and the latest peak timing (beat time) to the hand control processing. Note that, since an RRI value and a peak timing can be calculated using an existing technology (such as a technology disclosed in Unexamined Japanese Patent Application Publication No. 2021-45319), details of processing of the RRI calculation thread are omitted.

Next, the processor 110 starts a hand oscillation thread (step S102). The hand oscillation thread is also processing that is executed in parallel with the hand control processing and is processing of, by oscillating a hand, expressing pulses matching an RRI value and a peak timing. Details of processing of the hand oscillation thread is described later.

Next, the processor 110 causes the LED of the sensor 130 to emit light (step S103). Light having been emitted from the LED and reflected by the living body is received by the PD of the sensor 130, and the processor 110 acquires AD values to which received light intensity at the PD has been converted by the AD converter (step S104).

Next, the processor 110 inputs the acquired AD values to the RRI calculation thread (step S105). Next, the processor 110 determines whether or not an RRI value has been output from the RRI calculation thread (step S106). When no RRI value has been output (step S106; No), the processor 110 returns to step S103.

When an RRI value has been output (step S106; Yes), the processor 110 acquires the RRI value and a peak timing from the RRI calculation thread (step S107). Next, the processor 110 inputs the acquired RRI value and peak timing to the hand oscillation thread (step S108) and returns to step S103.

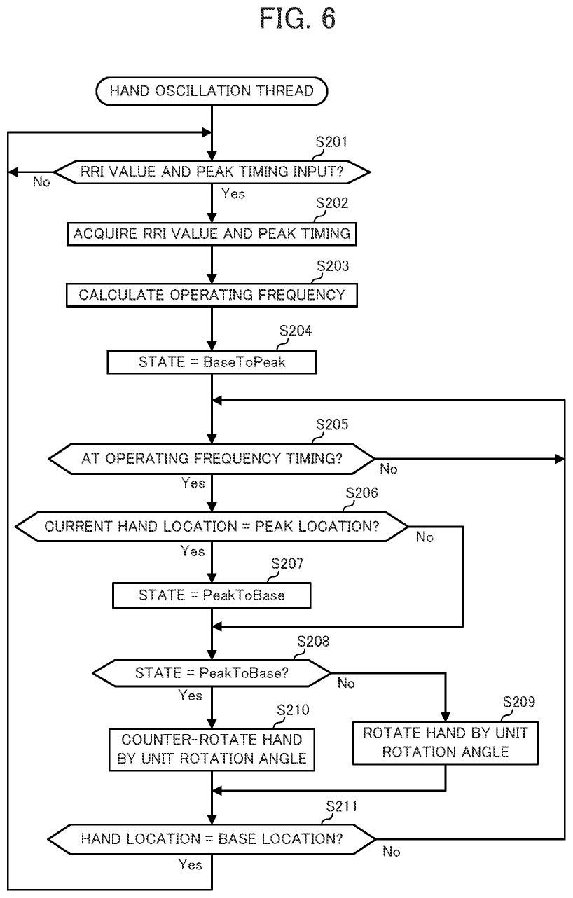

Next, the hand oscillation thread is described with reference to FIG. 6. Note that it is assumed that, as parameters of the hand oscillation thread, a standard rotation angle (for example, 135 degrees), a standard oscillation period (for example, 0.2 seconds), a unit rotation angle (for example, 1 degree), and a standard delay time (for example, 2 seconds) are set in advance.

The standard rotation angle is an angle by which the hand is rotated according to the pulsation of the heart (an angle equivalent to oscillation width (amplitude) of oscillation of the hand) and, in the example illustrated in FIG. 3, is an angle that the hand covers when the hand is rotated from the base location to the peak location. The standard oscillation period is a time required for the hand to start rotation and counter-rotation, the oscillation width of which is the standard rotation angle, from the base location and finally return to the base location and is a period of oscillation of the hand. The unit rotation angle is a rotation angle per control action at the time of controlling the hand to rotate in the hand oscillation thread. The standard delay time is a time lag between an actual peak timing and a timing at which the hand reaches the peak location.

In the present embodiment, although, since the hand is moved after a peak timing of AD values has been confirmed, a lag (delay) is caused to occur between the actual pulsation of the heart and the oscillation of the hand, it is possible to reduce the lag by reducing the standard delay time. However, since delay between an actual peak timing and a timing at which the RRI calculation thread outputs an RRI value and a peak timing is unavoidable, setting the standard delay time to approximately 1 second to 2 seconds is considered to be practical.

When the hand oscillation thread is started, the processor 110 first determines whether or not an RRI value and a peak timing are input from the hand control processing (step S201). When no RRI value and peak timing have been input from the hand control processing (step S201; No), the processor 110 returns to step S201. When an RRI value and a peak timing have been input from the hand control processing (step S201; Yes), the processor 110 acquires the RRI value and the peak timing (step S202).

Next, the processor 110 calculate an operating frequency (step S203). The operating frequency is a parameter that sets how often the hand is moved in the hand oscillation thread. Specifically, the processor 110 calculates an operating frequency using the formula below. The reason why the standard rotation angle is multiplied by 2 is that it is required to cause the hand to rotate back and forth through the standard rotation angle during the standard oscillation period.

Operating frequency=(standard rotation angle×2)/unit rotation angle/standard oscillation period

Next, the processor 110 assigns “BaseToPeak” to a variable representing a current state (step S204). This variable is a variable that represents in what direction the hand is to rotate. Since the hand is initially located at the base location and the processor 110 is to cause the hand to rotate from the base location toward the peak location, the processor 110 sets the value of the variable to “BaseToPeak”.

Next, the processor 110 determines whether or not the current timing is an operating frequency timing (step S205). Since the processor 110 controls the hand to oscillate with a delay from the actual pulsation by the standard delay time, the processor 110 determines that the current timing is not an operating frequency timing when the current time is earlier than a time calculated by “peak timing+standard delay time−standard oscillation period/2”. When the current time is a time calculated by “peak timing+standard delay time−standard oscillation period/2+operating frequency×n” (where n is an integer greater than or equal to 0 and less than or equal to a value calculated by “(standard rotation angle×2)/unit rotation angle”), the processor 110 determines that the current timing is an operating frequency timing.

When the current timing is not an operating frequency timing (step S205; No), the processor 110 returns to step S205.

When the current timing is an operating frequency timing (step S205; Yes), the processor 110 determines whether or not the current hand location is the peak location (step S206). When the current hand location is the peak location (step S206; Yes), the processor 110 assigns “PeakToBase” to the variable representing a state (step S207) and proceeds to step S208.

In contrast, when the current hand location is not the peak location (step S206; No), the processor 110 proceeds to step S208.

In step S208, the processor 110 determines whether or not the value of the variable representing a state is “PeakToBase”. When the value of the variable representing a state is not “PeakToBase” (step S208; No), the processor 110 rotates the hand by the unit rotation angle (step S209) and proceeds to step S211.

When the value of the variable representing a state is “PeakToBase” (step S208; Yes), the processor 110 counter-rotates the hand by the unit rotation angle (step S210) and proceeds to step S211.

In step S211, the processor 110 determines whether or not the current hand location is the base location (step S211). When the current hand location is not the base location (step S211; No), the processor 110 returns to step S205.

In contrast, when the current hand location is the base location (step S211; Yes), the processor 110 returns to step S201.

Through the hand control processing and the hand oscillation thread described above, the electronic device 100 acquires the number of pulsations of the heart and controls the display 140 to express a pulsation period based on the acquired number of pulsations of the heart with the hand. That is, since the electronic device 100 expresses the pulsation of the heart by oscillation of the hand, the user can grasp the pulsation of the heart more intuitively.

In addition, since the processor 110 starts rotation of the hand from the base location when the current time is a time calculated by “peak timing+standard delay time−standard oscillation period/2”, that is, at a timing earlier than a timing when the standard delay time has elapsed since a beat time by a time period half the standard oscillation period, the hand is controlled to be located at the peak location at a timing when the standard delay time has elapsed since the beat time. Therefore, ignoring a delay of the standard delay time, the user can grasp actual timings of the pulsation at timings at which the hand is located at the peak location.

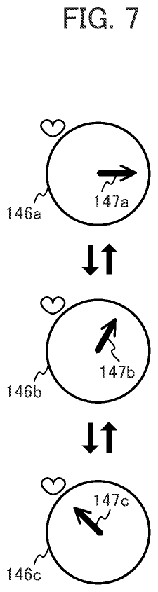

A manner in which the hand 147 in the small hand display 146 oscillates by the above-described hand control processing is described with reference to FIG. 7. In this example, it is assumed that the base location, the standard rotation angle, the standard oscillation period, and the standard delay time are set to the 3 o'clock direction, 135 degrees, 0.2 seconds, and 2 seconds, respectively.

Initially, as illustrated in the top row in FIG. 7, a hand 147a in a small hand display 146a is located at the base location. It is assumed that, from the RRI calculation thread, values “RRI value=0.8 seconds and peak timing=9:00:00” are output. The processor 110 then starts rotation of the hand 147 when the time is at 9:00:01.9 (=“peak timing+standard delay time−standard oscillation period/2”).

When the time is at 9:00:01.95 (=“peak timing+standard delay time−standard oscillation period/4”), a hand 147b in a small hand display 146b has rotated as illustrated in the second row in FIG. 7, and, when the time is at 9:00:02 (=“peak timing+standard delay time”), a hand 147c in a small hand display 146c rotates to the peak location as illustrated in the third row in FIG. 7.

Subsequently, the rotational direction of the hand turns to the reverse direction, and, when the time is at 9:00:02.05 (=“peak timing+standard delay time+standard oscillation period/4”), the hand 147b in the small hand display 146b has counter-rotated as illustrated in the second row in FIG. 7, and, when the time is at 9:00:02.1 (=“peak timing+standard delay time+standard oscillation period/2”), the hand 147a in the small hand display 146a returns to the base location as illustrated in the top row in FIG. 7.

As described above, since, in the small hand display 146, oscillation of the hand 147 is performed by rotation and counter-rotation the oscillation width of which is the standard rotation angle, it becomes easier to grasp the pulsation of the heart of the user.

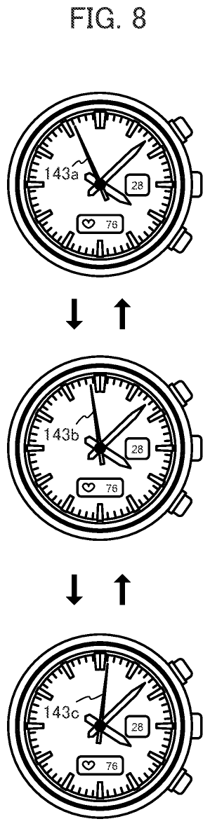

An example in which the second hand 143 is used as a hand to be oscillated in place of the hand 147 in the small hand display 146 is also described with reference to FIG. 8. In this example, it is assumed that the base location, the standard rotation angle, the standard oscillation period, and the standard delay time are set to a direction pointing to seconds of the current time, 30 degrees, 0.2 seconds, and 2.1 seconds, respectively.

For example, it is assumed that, at 16:07:55, values “RRI value=0.8 seconds and peak timing=16:07:54” are output from the RRI calculation thread. The processor 110 then starts rotation of the second hand 143 when the time is at 16:07:56 (=“peak timing+standard delay time−standard oscillation period/2”). Note that, at this point of time, as illustrated in the top row in FIG. 8, a second hand 143a is located at the base location (location at which the second hand 143a points to 56 seconds, which are seconds of the current time).

When the time is at 16:07:56.05 (=“peak timing+standard delay time−standard oscillation period/4”), a second hand 143b has rotated to the location at which the second hand 143b points to 58.5 seconds as illustrated in the second row in FIG. 8, and, when the time is at 16:07:56.1 (=“peak timing+standard delay time”), a second hand 143c rotates to the peak location (location at which the second hand 143c points to 1 second) as illustrated in the third row in FIG. 8.

Subsequently, the rotational direction of the second hand 143 turns to the reverse direction, and, when the time is at 16:07:56.15 (=“peak timing+standard delay time+standard oscillation period/4”), the second hand 143b has counter-rotated as illustrated in the second row in FIG. 8, and, when the time is at 16:07:56.2 (=“peak timing+standard delay time+standard oscillation period/2”), the second hand 143a returns to the base location (location at which the second hand 143a points to 56 seconds, which are seconds of the current time) as illustrated in the top row in FIG. 8.

As described above, even when the pulsation is expressed by the second hand 143, the electronic device 100 is capable of displaying correct seconds with the second hand 143 at any time other than during a period of time of the standard oscillation period (in the above-described example, 0.2 seconds). In addition, the user can grasp pulses intuitively through oscillation of the second hand 143 during a period of time of the standard oscillation period.

Note that the reason why, in the above-described example, the standard delay time is set to 2.1 seconds is that it is considered that, for the sake of description, a configuration in which the seconds of the time do not change between timings at which the oscillation of the second hand 143 is started and ended is more easily understood. Even when the seconds of the time change between the timings at which the oscillation of the second hand 143 is started and ended, no significant problem occurs when the processor 110 controls the second hand 143 to stop counter-rotation at a point of time when the second hand 143 has counter-rotated to a location at which the second hand 143 points to seconds of the current time.

Note that, although, in the above-described embodiment, it is assumed that the rotational velocity when the hand rotates from the base location to the peak location is set the same as the rotational velocity when the hand counter-rotates from the peak location to the base location, the rotational velocity may be changed between at the time of rotation and at the time of counter-rotation.

In addition, the standard oscillation period may be changed according to the RRI value. For example, when the standard oscillation period is defined as

standard oscillation period=RRI/x (where x is any real number greater than or equal to 1),

the rotational velocity of the hand and the pulse rate become proportional to each other, and the user thus becomes able to easily grasp the magnitude of pulse rate intuitively through the rotational velocity of the hand.

In addition, in the above-described embodiment, the processor 110 expresses oscillation by starting the rotation of the hand from the base location, reversing the rotational direction when the hand has rotated by the standard rotation angle (at the peak location), and stopping the rotation when the hand has returned to the base location. Although, in this case, the central location of the oscillation of the hand is a location to which the hand rotates from the base location by half the standard rotation angle, the central location of the oscillation expressed by the hand is not limited to the location.

For example, the processor 110 may express oscillation by starting the rotation of the hand from the base location, reversing the rotational direction when the hand has rotated to half the standard rotation angle (at the peak location), reversing the rotational direction again when the hand, having passed the base location, has further counter-rotated to half the standard rotation angle, and stopping the rotation when the hand has returned to the base location again.

In this case, the processor 110 starts the rotation of the hand from the base location when the current time is at a time calculated by “peak timing+standard delay time−standard oscillation period/4”, and reverses the rotational direction at the peak location (when the current time is at a time calculated by “peak timing+standard delay time”). Then, the hand passes the base location when the current time is at a time calculated by “peak timing+standard delay time+standard oscillation period/4”, and the hand reaches a location at which the hand has counter-rotated beyond the base location by half the standard rotation angle when the current time is at a time calculated by “peak timing+standard delay time+standard oscillation period/2”, where the processor 110 reverses the rotational direction. When the current time is at a time calculated by “peak timing+standard delay time+3×standard oscillation period/4”), the hand returns to the base location again and the processor 110 stops the rotation of the hand.

Since, in this example, the central location of the oscillation of the hand is the base location, the processor 110 is capable of expressing pulsation with less feeling of strangeness by the oscillation of the hand, depending on a waveform of the pulsation.

Further, the central location of the oscillation of the hand is not limited to a location to which the hand is rotated from the base location by half the standard rotation angle and the base location. The processor 110 may be configured to oscillate the hand with a location to which the hand is rotated or counter-rotated from the base location by an arbitrary angle less than or equal to the standard rotation angle as the central location of the oscillation of the hand (standard oscillation central location). This configuration enables the processor 110 to express, for example, oscillation that better fits the waveform of pulsation, with the hand.

Variation 1

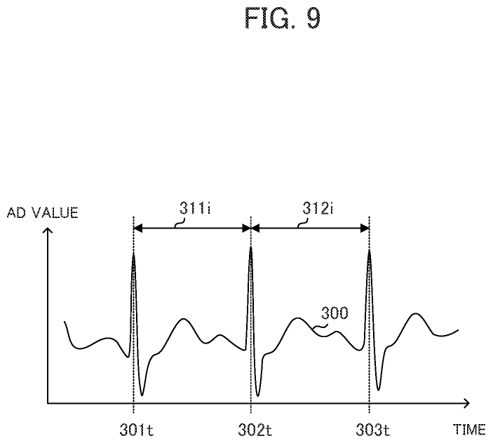

In the above-described embodiment, it was configured such that the sensor 130 included the PPG sensor and acquired a PPG waveform as illustrated in FIG. 2. However, waveforms with which the electronic device 100 deals are not limited to the PPG waveform. As Variation 1, an embodiment is conceivable in which the sensor 130 includes an ECG sensor and, based on AD values to which voltage values that the ECG sensor outputs are AD-converted, the processor 110 acquires a waveform 300 (ECG waveform) as illustrated in FIG. 9.

In this case, the processor 110 is also capable of, by detecting peak values of the AD values, extracting beat times 301t, 302t, and 303t and acquiring intervals 311i and 312i between the beat times as RRIs, as illustrated in FIG. 9. Therefore, even when using an ECG waveform, the processor 110 is capable of executing the above-described respective pieces of processing (hand control processing and the like).

As described above, when the sensor 130, even when not including a PPG sensor, includes another sensor (for example, an ECG sensor) that can detect pulsation of a living body, the processor 110 is capable of expressing the pulsation by oscillation of a hand.

Variation 2

In addition, the processor 110 does not necessarily have to calculate an RRI by analyzing a waveform. For example, as described above, an average RRI value can be calculated from a pulse rate using the formula below:

average value of RRIs for one minute during which the pulse rate is measured=60/pulse rate.

Therefore, as Variation 2, an embodiment is conceivable in which an average RRI value is calculated from a pulse rate and, based on the RRI value, pulsation is expressed by oscillation of a hand.

In Variation 2, it is assumed that, in place of the above-described RRI calculation thread, pulse rate calculation thread is being executed in parallel with other processing, and pulse rates are periodically (at every pulse rate calculation interval) output to the processor 110. Since a pulse rate can also be calculated using an existing technology (such as a technology disclosed in Unexamined Japanese Patent Application Publication No. 2015-58022), details of processing of the pulse rate calculation thread are omitted.

Every time a pulse rate is acquired, the processor 110 calculates an RRI value, assuming “RRI=60/pulse rate” and, using a value obtained by adding the calculated RRI value to the latest peak timing as the next peak timing, performs processing of inputting the RRI value and the peak timing to the hand oscillation thread.

Even when an accurate peak timing and RRI value are unknown, performing processing described above enables the processor to express pulsation that does not cause a feeling of strangeness by the oscillation of the hand, based on the pulse rate.

Other Variations

In addition, expression of pulsation of the heart by the electronic device 100 is not limited to expression by oscillation of a hand. The electronic device 100 may express pulsation by, for example, causing the outputter 180 to output sound with sound volume changed in an oscillational manner. In this case, the processor 110, for example, starts outputting a small sound at a point of time when the time is at a time calculated by “peak timing+standard delay time−standard oscillation period/2”, gradually increases the sound volume, maximizes the sound volume at a point of time when the time is at a time calculated by “peak timing+standard delay time”, subsequently gradually decreases the sound volume, and stops outputting the sound at a point of time when the time is at a time calculated by “peak timing+standard delay time+standard oscillation period/2”.

In addition, the electronic device 100 may include a vibrator to vibrate the electronic device 100 as the outputter 180 and express pulsation by changing the amplitude of the vibration, which is caused by the vibrator, in an oscillational manner. In this case, the processor 110, for example, starts a small vibration at a point of time when the time is at a time calculated by “peak timing+standard delay time−standard oscillation period/2”, gradually increases the amplitude of the vibration, maximizes the amplitude of the vibration at a point of time when the time is at a time calculated by “peak timing+standard delay time”, subsequently gradually decreases the amplitude of the vibration, and stops the vibration at a point of time when the time is at a time calculated by “peak timing+standard delay time+standard oscillation period/2”.

In addition, the electronic device 100 may include a light emitter (such as an LED) as the outputter 180 and express pulsation by changing the intensity of light emission by the light emitter in an oscillational manner. In this case, the processor 110, for example, starts emission of substantially dim light by the LED at a point of time when the time is at a time calculated by “peak timing+standard delay time−standard oscillation period/2”, gradually increases the brightness of the LED, maximizes the brightness of the LED at a point of time when the time is at a time calculated by “peak timing+standard delay time”, subsequently gradually decreases the brightness, and stops the light emission at a point of time when the time is at a time calculated by “peak timing+standard delay time+standard oscillation period/2”.

In addition, the processor 110 may, in addition to expressing pulsation of the heart by oscillation of a hand, express the pulsation of the heart, using at least one of the above-described sound, vibration, and light.

Although, in the embodiment described thus far, the description was made assuming that the electronic device 100 expresses pulsation of the heart (heartbeat) or pulsation of arteries (pulse) by oscillation of a hand or the like, the pulsation that the electronic device 100 expresses is not limited to pulsation of the heart or arteries. For example, the processor 110 may detect pulsation of the lungs (expansion and contraction of the lungs) using the sensor 130 and express the pulsation of the lungs by oscillation of a hand or the like.

In addition, the electronic device 100 may increase and decrease types of sensors provided to the sensor 130 as needed, and the processor 110 may express arbitrary pulsation of a living body that is acquirable from the sensor 130 by oscillation of a hand or the like. In addition, although, in the above-described embodiment, the processor 110 acquired a pulse rate, which is the number of pulses per minute, the processor may acquire not only the pulse rate but also the number of pulsations of a living body during a predetermined period (for example, one minute).

Note that the electronic device 100 can also be achieved by a wearable computer that the user can wear on the body or a computer, such as a smartphone, a tablet, and a PC, that can acquire detection values that sensors worn on the body of the user detected. Specifically, in the above-described embodiment, the description was made assuming that programs, such as a program executing the hand control processing, that the electronic device 100 executes are stored in the storage 120 in advance. However, a computer that can execute the above-described processing may be configured by storing programs in a non-transitory computer-readable recording medium, such as a flexible disk, a compact disc read only memory (CD-ROM), a digital versatile disc (DVD), a magneto-optical (MO) disc, a memory card, and a USB memory, and distributing the non-transitory recording medium, and reading and installing the programs in the computer.

Further, it is possible to superimpose the programs on a carrier wave and apply the programs via a communication medium, such as the Internet. For example, the programs may be posted on a bulletin board system (BBS) on a communication network and distributed via the BBS. It may be configured such that starting up and executing the distributed programs in a similar manner to other application programs under the control of the operating system (OS) enables the above-described processing to be executed.

In addition, the processor 110 may be configured not only by any type of processor, such as a single processor, multiple processors, and a multi-core processor, alone but also by combining such any type of processor and a processing circuit, such as an application specific integrated circuit (ASIC) and a field-programmable gate array (FPGA).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An electronic device comprising:
a display to display information with a hand; and
at least one processor,
wherein the processor is configured to:
acquire a number of pulsations of a living body during a predetermined period; and
control the display to express a pulsation period based on the acquired number of pulsations of the living body with the hand.

2. The electronic device according to claim 1, wherein the processor is configured to control the display to express a pulsation period based on the acquired number of pulsations of a living body by oscillation of the hand in a form of rotation and counter-rotation having oscillation width equal to a standard rotation angle.

3. The electronic device according to claim 2, wherein the processor is configured to determine rotational velocity of the hand in such a manner that the larger the acquired number of pulsations is, the faster the rotational velocity becomes.

4. The electronic device according to claim 2, wherein the processor is configured to determine the standard rotation angle in such a manner that the larger the acquired number of pulsations is, the larger the standard rotation angle becomes.

5. The electronic device according to claim 2, wherein the processor is configured to cause oscillation of the hand to be started from a base location that is a start location of the oscillation.

6. The electronic device according to claim 5, wherein the processor is configured to:
acquire a beat time that is a time at which the pulsation reaches a local maximum point; and
cause the hand to oscillate in such a way that the hand is located at a peak location that is a location of a local maximum point of the oscillation at a timing at which a standard delay time has elapsed since the acquired beat time.

7. The electronic device according to claim 6, wherein the processor is configured to cause oscillation of the hand to be started from the base location at a timing earlier than a timing at which a standard delay time has elapsed since the acquire beat time by a time period half a standard oscillation period.

8. The electronic device according to claim 7, wherein the processor is configured to change the standard oscillation period according to the acquired number of pulsations.

9. The electronic device according to claim 5, wherein
the hand is a second hand,
the base location is a location corresponding to seconds of a current time, and
the processor is configured to, while causing the hand to indicate the seconds, cause the hand to oscillate.

10. The electronic device according to claim 2, wherein the processor is configured to cause the hand to oscillate in such a manner that a central location of the oscillation coincides with a standard oscillation central location.

11. The electronic device according to claim 1, wherein the pulsation is pulses.

12. The electronic device according to claim 1, wherein the processor acquires, as the number of pulsations of a living body during the predetermined period, the number of pulsations per unit time of the living body.

13. A method executed by an electronic device,
the electronic device comprising:
a display to display information with a hand; and
at least one processor, and
the method comprising:
acquiring a number of pulsations of a living body during a predetermined period; and
controlling the display to express a pulsation period based on the acquired number of pulsations of the living body with the hand.

14. The method according to claim 13, the method further comprising controlling the display to express a pulsation period based on the acquired number of pulsations of a living body by oscillation of the hand in a form of rotation and counter-rotation having oscillation width equal to a standard rotation angle.

15. The method according to claim 14, the method further comprising causing oscillation of the hand to be started from a base location that is a start location of the oscillation.

16. The method according to claim 15, wherein
the hand is a second hand,
the base location is a location corresponding to seconds of a current time, and
the method further comprises, while causing the hand to indicate the second, causing the hand to oscillate.

17. A non-transitory recording medium storing a program readable by a computer of an electronic device,
the electronic device comprising:
a display to display information with a hand; and
at least one processor,
wherein the processor, in accordance with the program, executes the following processing of:
acquiring a number of pulsations of a living body during a predetermined period; and
controlling the display to express a pulsation period based on the acquired number of pulsations of the living body with the hand.

18. The non-transitory recording medium according to claim 17, wherein
the processor, in accordance with the program, further executes the following processing of
controlling the display to express a pulsation period based on the acquired number of pulsations of a living body by oscillation of the hand in a form of rotation and counter-rotation having oscillation width equal to a standard rotation angle.

19. The non-transitory recording medium according to claim 18, wherein
the processor, in accordance with the program, further executes the following processing of
causing oscillation of the hand to be started from a base location that is a start location of the oscillation.

20. The non-transitory recording medium according to claim 19, wherein
the hand is a second hand,
the base location is a location corresponding to seconds of a current time, and
the processor, in accordance with the program, further executes the following processing of, while causing the hand to indicate the seconds, causing the hand to oscillate.
